(19) United States
(12) Patent Application Publication
(10) Pub. No.: US 2022/0316098 A1
(43) Pub. Date: Oct. 6, 2022

(54) MODIFIED CHEMICAL FIBER FILLED WITH MULTI-ORIENTED GRAPHENE/POLYMER COMPOSITE AND PREPARATION METHOD THEREOF

(71) Applicant: ZHEJIANG SCI-TECH UNIVERSITY, Hangzhou (CN)

(72) Inventors: Dongming Qi, Hangzhou (CN); Jicheng Wang, Hangzhou (CN); Huajun Huang, Hangzhou (CN); Jiawei Li, Hangzhou (CN); Yangyi Sun, Hangzhou (CN)

(21) Appl. No.: 17/608,139

(22) PCT Filed: Oct. 28, 2020
(86) PCT No.: PCT/CN2020/124224

§ 371 Date: Nov. 1, 2021

(30) Foreign Application Priority Data
Sep. 3, 2020 (CN) 202010914749.2

(51) Int. Cl. D01F 6/52; D01F 1/10; C08F 212/08; C08F 220/56; C08F 220/14

(52) U.S. Cl. CPC D01F 6/52; D01F 1/10; C08F 212/08; C08F 220/56; C08F 220/14

(57) ABSTRACT

A graphene/polymer microsphere a modified chemical fiber filled with a multi-oriented graphene/polymer composite and a preparation method are disclosed. Graphene is coated by an in-situ suspension polymerization, which greatly improves the dispersion effect of graphene. Comonomers are used to increase the compatibility between graphene and polymers, so that a strong interaction between graphene and polymers is formed. The graphene/polymer microsphere with low melting point and high toughness is used to fill a chemical fiber, and is oriented therein to modify the chemical fiber. The graphene/polymer microspheres could be oriented to form a microfibril structure with a high aspect ratio in the chemical fiber.

### CROSS REFERENCE TO RELATED APPLICATION

This application claims the benefit and priority of Chinese Patent Application No. 202010914749.2 with a title of “Method for Preparing Modified Chemical Fiber Filled with Multi-oriented Graphene/Polymer Composite,” filed with the Chinese National Intellectual Patent Administrate on Sep. 3, 2020, the disclosure of which is incorporated by reference herein in its entirety for all purposes.

### TECHNICAL FIELD

The present disclosure relates to the technical field of fiber modification, in particular to a modified chemical fiber filled with a multi-oriented graphene/polymer composite and a preparation method thereof.

### BACKGROUND ART

With the continuous development of the fiber processing industry, the output and product types of various synthetic chemical fibers are increasing, and the tentacles of products in the textile fiber-related fields continue to extend, allowing that a variety of fiber products are gradually affecting people's lives. The modification of fiber materials mainly includes chemical modification and physical modification. Chemical modification is mainly to adjust the water absorption, crstallinity, crystallization speed, and glass transition temperature of the fiber by changing the chemical structure of the polymer main chain or side chain (Printing and Dyeing, 2019, 45(23): 6-10+25), which thereby affects the strength, abrasion resistance, strong acid (alkali) resistance, flame retardancy, light stability, and other properties involved during its use (Fibers & Textiles in Eastern Europe, 2020, 28(140): 29-34). Such method needs to be carried out in the raw material synthesis stage, and thus has higher requirements for the matching degree of the whole process of fiber processing.

Physical modification usually only needs to be carried out in the forming stage, and does not influence the front-end process. It may include two-phase/multiphase blending modification and nano-particle filling modification. Blending modification refers to a modification by mixing a fiber matrix with one or more other polymers that are incompatible or partially compatible with the fiber matrix, thereby obtaining the corresponding polymer alloy. For example, Qi Dongming et al. (CN107435171B) modified polyester fibers by blending with PAcr microspheres, and the mechanical properties of the fibers was improved by oriented microfibrils. Guo Hong et al. (China Plastics, 2019,33(04):1-5) modified PA66 by blending maleic anhydride grafted polyolefin elastomer (as a toughening agent) with PA66, and the impact strength of the modified PA66 obtained under high-cold conditions (−50° C.) was increased by 350%. Zhang Jingchun et al. (Synthetic Fiber Industry, 2019, 42(05): 1-6) used polybutylene terephthalate-polytetramethylene ether glycol (PBT-PTMEG) as a modifier, subjected it and polybutylene terephthalate (PBT) to a blend spinning. The ether bonds in the polyether ester segment could impart higher softness to the PBT fiber, thereby achieving a wool-like feel. The breaking strength under the best formula obtained was reduced by 3%, and the elongation at break was increased by 83.7%. Fu Qiang et al (Chinese Journal of Polymer Science, 25(06), 599) prepared a PP/PA6/PP-g-MA composite material by a melt blending stretching-injection molding method. It was found that the in-situ formed PA6 microfibrils could improve the mechanical properties of the composite material. The above researches show that the mechanical properties of the fiber could be improved through blending modification, but it is necessary to introduce a certain compatibilizer (such as maleic anhydride) in the preparation process to increase the compatibility of the blend system. However, a compatibilizer could usually only be applicable to specific composition conditions, and sometimes it is difficult to synthesize the compatibilizer for special blending system. Therefore, the purpose for wide regulation of blending system is hard to be achieved through the addition of compatibilizer. Meanwhile, due to the inability to balance the strength and toughness of the fiber, these limitations have led to difficulties in obtaining an ideal fiber material.

It is one of the functional modification methods for fiber to fill functional material particles inside the fiber or adsorb functional material particles on the surface of the fiber. Duan et al. (Polymers, 2019, 11(3)) used the modified nanoclay (Mclay) with cetyltrimethylammonium bromide as an inorganic filler, and prepared the high molecular weight PA66/Mclay nanocomposites by an in-situ polymerization and a solid-state polycondensation process. Due to the introduction of Mclay, the mechanical properties of the resulting modified PA66 fibers was increased while its melt viscosity decreased. Zhang et al. (Micro & Nano Letters, 2019,14(14):1376-1380) mixed modified carbon black particles with sodium polystyrene sulfonate with PA6 and then spun to antistatic PA6 fibers. The fibers obtained exhibit comparative mechanical properties and decreased resistivity by 4 orders of magnitude. Gao Chao et al. (CN107513151B, CN106906534B) mixed graphene oxide with polyester precursor and caprolactam respectively, subjected them to an in-situ polymerization initiated by high temperature, the obtained masterbatch was sliced then the graphene filled composited fiber was prepared by melt blending. Liang Dong et al. [Journal of Applied Polymer Science, 104(4), 2288-2296] prepared a PET/PA6/SiO₂ ternary blend system, in which SiO₂ was selectively distributed at the PET/PA6 phase interface, and the system could improve the toughness of the material. These studies have provided ideas for filler modification methods of fibers, but the above-mentioned fillers are mainly randomly distributed in the material. The utilization efficiency of the filler could be greatly improved by further regulating the orientation of the filler particles in the fiber, and meanwhile, the special properties of the anisotropic filler could be exerted better in this way. Therefore, the construction of the orientation structure of the filler particles in the fiber modification research is one of the emerging directions.

### SUMMARY

An object of the present disclosure is to provide a modified chemical fiber filled with a multi-oriented graphene/polymer composite and a preparation method thereof. The method according to the disclosure makes it possible to simultaneously solve the problem of system compatibility and the increase of melt viscosity caused by inorganic filler(s) on the basis of realizing the dispersion and controllable and orderly arrangement of graphene.

In order to achieve the above-mentioned object of the present disclosure, the present disclosure provides the following technical solutions;

The present disclosure provides a method for preparing a graphene/polymer microsphere, including the following steps:

mixing graphene, a propylene monomer, an acrylate monomer, a comonomer, a macromolecular crosslinking agent, and an initiator to obtain a mixed solution;

mixing the mixed solution with an aqueous dispersion system and homogenizing, to obtain a suspension; and

subjecting the suspension to an in-situ suspension polymerization reaction to obtain the graphene/polymer microsphere.

The present disclosure provides a method for preparing a modified chemical fiber filled with a multi-oriented graphene/polymer composite, including the following steps:

mixing graphene, a propylene monomer, an acrylate monomer, a comonomer, a macromolecular crosslinking agent, and an initiator, to obtain a mixed solution;

mixing the mixed solution with an aqueous dispersion system and homogenizing to obtain a suspension:

subjecting the suspension to an in-situ suspension polymerization reaction to obtain a graphene/polymer microsphere; and

mixing the graphene/polymer microsphere and a chemical fiber matrix in a twin-screw extruder, and subjecting the resulting blends to a melt blending, an extrusion, and a drawing, to obtain the modified chemical fiber filled with a multi-oriented graphene/polymer composite.

In some embodiments, a mass ratio of the propylene monomer, the acrylate monomer, and the comonomer is in the range of 15-50: 10-40: 10-45.

In some embodiments, the propylene monomer includes one or more selected from the group consisting of acrylamide, methacrylamide, ethacrylamide, N-(3-dimethylaminopropyl)-methacrylamide, N,N-dimethylacrylamide, N,N-diethylacrylamide, acrylonitrile, and methyl methacrylate.

In some embodiments, the acrylate monomer includes butyl acrylate or butyl methacrylate.

In some embodiments, the comonomer is styrene.

In some embodiments, the macromolecular crosslinking agent is poly(ethylene glycol) dimethacrylate, poly(ethylene glycol) diacrylate, or a mixture thereof: the macromolecular crosslinking agent is in amount of 0.1-0.5% of the total mass of the propylene monomer, the acrylate monomer, and the comonomer.

In some embodiments, under the condition that the macromolecular crosslinking agent is a mixture of poly(ethylene glycol) dimethacrylate and poly(ethylene glycol) diacrylate, a mass ratio of poly(ethylene glycol) dimethacrylate to poly(ethylene glycol) diacrylate is ranging from 9:1 to 1:9.

In some embodiments, the initiator is azobisisobutyronitrile, benzoyl peroxide, or a mixture thereof: the initiator is in an amount of 0.1-6% of the total mass of the propylene monomer, the acrylate monomer, and the comonomer.

In some embodiments, the graphene is is in an amount of 0.05-1% of the total mass of the propylene monomer, the acrylate monomer, and the comonomer.

In some embodiments, the aqueous dispersion system is obtained by mixing a dispersant and a salt solution; the dispersant includes one or more selected from the group consisting of magnesium hydroxide, activated calcium phosphate, and polyvinyl alcohol; the salt solution is an aqueous solution of sodium nitrite and sodium chloride.

In some embodiments, the homogenizing is carried out under a condition of a high-speed stirring, with a stirring speed of 10,000-28,000 rpm.

In some embodiments, the in-situ suspension polymerization reaction is carried out in a protective atmosphere: the in-situ suspension polymerization reaction is carried out at a temperature of 50-80° C. for 8-24 hours.

In some embodiments, the graphene/polymer microspheres are structured by coating graphene with polymer, and has an average particle size of 20-200 μm, and a gel rate of 30-65%.

In some embodiments, a mass ratio of the graphene/polymer microsphere to the chemical fiber matrix is in the range of 10-50: 50-90.

In some embodiments, the chemical fiber matrix includes one or more selected from the group consisting of nylon, polyester, polyacrylonitrile, polypropylene, and polymethyl methacrylate.

The present disclosure also provides a modified chemical fiber filled with a multi-oriented graphene/polymer composite prepared by the method as described in the above technical solutions, wherein an oriented microfibril structure is formed in the chemical fiber matrix from the polymer microsphere, in which graphene is oriented.

The present disclosure provides a method for preparing a modified chemical fiber filled with a multi-oriented graphene/polymer composite, including the following steps: mixing graphene, a propylene monomer, an acrylate monomer, a comonomer, and a macromolecules crosslinking agent, and an initiator to obtain a mixed solution; mixing the mixed solution with an aqueous dispersion system, and homogenizing to obtain a suspension; subjecting the suspension to an in-situ suspension polymerization reaction to obtain a graphene/polymer microsphere; mixing the graphene/polymer microsphere and a chemical fiber matrix in a twin-screw extruder, and subjecting the resulting mixture to a melt blending, an extrusion, and a drawing to obtain the modified chemical fiber filled with a multi-oriented graphene/polymer composite. In the present disclosure, graphene is coated by an in-situ suspension polymerization, which greatly improves the dispersion effect of graphene. The combination of comonomers increases the compatibility between graphene and thepolymer, so that a strong interaction could be generated between graphene and the polymer microspheres. In the present disclosure, a graphene/polymer microsphere with low melting point and high toughness is used to fill a chemical fiber, and is orientated therein to modify the chemical fiber, which could increase the strength and toughness of the chemical fiber, and is expected to improve the electrical and thermal conductivity of chemical fiber products. The graphene/polymer microsphere could be oriented to form a microfibril structure with a high aspect ratio inside a single chemical fiber. On the one hand, such structure could inhibit the formation of cracks in the radial direction (the main breaking direction of the fiber), and on the other hand, it could induce the high orientation and crystallization of the polymer molecules in the chemical fiber matrix, and increase the strength of the fiber material. In addition, the dust generated during the blending of the coated graphene is greatly reduced, compared with the original graphene, which is conductive to the improvement of the spinning processing operation environment. The coated graphene is only oriented in the microfibrils with a high aspect ratio, and the percolation threshold is greatly reduced. Further, there is no migration during use, and the service life is long. The graphene/polymer microsphere is used to modify the chemical fiber matrix, which could avoid the increase in melt viscosity and the wear of the filler particles on the barrel and die encountered during conventional blending, which is conducive to energy saving and consumption reduction.

The method according to the present disclosure is highly controllable, widely applicable, and could be used to modify fibers with multiple scales and multiple cross-sectional shapes.

### BRIEF DESCRIPTION OF THE DRAWINGS

FIG. 1 shows an orientation deformation mechanism of the graphene/polymer microsphere.

FIG. 2 shows a flow chart of the preparation of the modified PA fiber filled with oriented graphene.

FIG. 3 shows a SEM image of the longitudinal cross-section of the modified PMMA fiber filled with oriented graphene as prepared in Example 1.

FIG. 4 shows an axial TEM image of the modified PA fiber filled with oriented graphene as prepared in Example 4.

FIG. 5 shows a TEM image of the longitudinal section of the modified PA fiber filled with oriented graphene as prepared in Examples 5 to 6.

FIG. 6 shows the optical pictures and particle size distribution diagrams of the graphene/polymer microspheres as prepared in Examples 7 to 8.

FIG. 7 shows the stress-strain curves of the modified PA fiber filled with oriented graphene obtained in Example 10 and the pure PA fiber.

FIG. 8 shows an axial TEM image of the modified PA fiber obtained in Comparative Example 1.

### DETAILED DESCRIPTION OF THE EMBODIMENTS

The present disclosure provides a method for preparing a modified chemical fiber filled with a multi-oriented graphene/polymer composite, including the following steps:

mixing graphene, a propylene monomer, an acrylate monomer, a comonomer, a macromolecular crosslinking agent, and an initiator to obtain a mixed solution:

mixing the mixed solution with an aqueous dispersion system, and homogenizing to obtain a suspension:

subjecting the suspension to an in-situ suspension polymerization reaction to obtain a graphene/polymer microsphere: and

mixing the graphene/polymer microsphere and a chemical fiber matrix in a twin-screw extruder, and subjecting the resulting mixture to a melt blending, an extrusion, and a drawing, to obtain the modified chemical fiber filled with a multi-oriented graphene/polymer composite.

In the present disclosure, unless otherwise specified, the raw materials used for the preparation are all commercially available products well known to those skilled in the art.

In the present disclosure, graphene, the propylene monomer, the acrylate monomer, the comonomer, the macromolecular crosslinker, and the initiator are mixed to obtain a mixed solution. In some embodiments of the present disclosure, a mass ratio of the propylene monomer, the acrylate monomer, and the comonomer is in the range of 15-50: 10-40: 10-45, and more preferably 40:20:40. In the present disclosure, the compatibility between the components is controlled by adjusting the types and proportions of the above three types of monomers, wherein the propylene monomer is mainly to control the interface compatibility between the polymer microsphere and chemical fiber, and the comonomer is mainly to control the interface compatibility between graphene and polymer microspheres. Due to the poor polarity and the existence of π-π effect, graphene is easy to aggregate and is incompatible with most chemical fiber matrices. The polarity and group types of chemical fiber matrix are diverse, and by adjusting types and contents of the comonomers with different polarities and functional groups, it is possible to adjust the polarity and functional groups of polymer microspheres, thereby adjusting the interface compatibility between polymer microspheres and chemical fiber matrix according to the “similar compatible principle”. According to the π-π conjugation effect, the π-π interaction between the molecular chain and the graphene could be formed by adjusting the structure content such as benzene ring in the polymer microspheres, thereby controlling the interface strength between the graphene and polymer microspheres. The acrylate monomer is used to control the flexibility of the polymer molecular chain to allow the motion ability thereof to meet high deformation requirement.

In some embodiments of the present disclosure, the acrylic monomer include one or more of acrylamide, methacrylamide, ethacrylamide, N-(3-dimethylaminopropyl)-methacrylamide, N,N-dimethylacrylamide, N,N-diethylacrylamide, acrylonitrile, and methyl methacrylate. Under the condition that the propylene monomer includes two or more monomers, there is no special requirement on the ratio among each monomer, and any ratio may be used.

In some embodiments of the present disclosure, the acrylate monomer includes butyl acrylate or butyl methacrylate.

In some embodiments of the present disclosure, the comonomer is styrene.

In some embodiments of the present disclosure, the macromolecular crosslinking agent is poly(ethylene glycol) dimethacrylate, poly(ethylene glycol) diacrylate, or a mixture thereof, and more preferably a mixture of poly(ethylene glycol) dimethacrylate and poly(ethylene glycol) diacrylate. In some embodiments of the present disclosure, the number average molecular weight of the poly(ethylene glycol) dimethacrylate (PEGDMA) is in the range of 550-750, and the number average molecular weight of the poly(ethylene glycol) diacrylate (PEGDA) is 200-1,000. In the present disclosure, under the condition that the macromolecular crosslinking agent is a mixture of poly(ethylene glycol) dimethacrylate and poly(ethylene glycol) diacrylate, the mass ratio of the poly(ethylene glycol) dimethacrylate and poly(ethylene glycol) diacrylate is in the range of 9:1-1:9, and more preferably 1:1. In some embodiments of the present disclosure, the macromolecular crosslinking agent is in an amount of 0.1-0.5% of the total mass of the propylene monomer, the acrylate monomer, and the comonomer, more preferably 0.3-0.4%. In the present disclosure, compared with conventional small-molecule crosslinking agents, the distance between the crosslink points in the crosslinked structure formed by the macro-molecular crosslinking agent is larger, and the movement ability of the cross-linked network chain is greater. Therefore, the resulting cross-linked microsphere has stronger deformability and is easier to deform and orient in the fiber-forming flow field. Under the condition that two cross-linking agents with a molecular weight difference of several times are used in combination, the cross-linked structure formed by the polymerization process has a dense crosslinked network formed by a lower molecular weight crosslinking agent PEGDA and a loose crosslinked network formed by a higher molecular weight crosslinking agent PEGDMA. The denser cross-linked structure formed by PEGDA exhibits more resistant to external stress, which could reduce the rupture of the microspheres in the fiber-forming flow field. The looser cross-linked structure formed by PEGDMA endows the microspheres with stronger deformability, making the microspheres more deformable and easier to orient and to form microfibrils with a high aspect ratio in the fiber-forming flow field.

In the present disclosure, the macromolecular crosslinking agent as defined with such amount above could result in a gel rate of the polymer microspheres of 30-65%, which is conductive to the improvement of microfibrillation efficiency of the polymer microspheres. In the present disclosure, when the gel rate of the microspheres is too high (>65%), the number of crosslink points in the cross-linked structure will be too large, the average length of the cross-linked network will decrease, and the ability of movement thereof will be greatly reduced. Furthermore, the deformability of the microspheres in the fiber-forming flow field decreases, and the microfibril structure with a high aspect ratio could not be formed by orientation. When the gel rate is too low (<30%), there are a large number of molecular chains in the graphene/polymer microspheres that are not involved in the crosslinking reaction, which will cause the microspheres to be severely broken in the fiber-forming flow field, and thus it is impossible to form a controllable one-dimensional alignment structure of graphene (rGO) in the microfibril. In the specific embodiment of the present disclosure, when the gel rate of the graphene/polymer microspheres reaches 40-55%, the microsphere has moderate deformability, and is easy to deform and orient to form a microfibril structure in the fiber-forming flow field, with an aspect ratio reaching 100. In that case, rGO is distributed in a good state in the microfibrils, presenting an orientation structure aligned along the axial direction of the microfibrils, and the degree of orientation of rGO could be adjusted through the drawing process.

In the specific embodiment of the present disclosure, a mixture of poly(ethylene glycol) dimethacrylate and poly(ethylene glycol) diacrylate is used as the crosslinking agent, and the two crosslinking agents allow that a “loose-dense” double cross-linked structure is formed, which could endow the polymer microspheres with high deformability and induce the orientation and alignment of the graphene in the fiber-forming flow field.

In some embodiments of the present disclosure, the initiator is azobisisobutyronitrile, benzoyl peroxide, or a mixture thereof, and more preferably a mixture of azobisisobutyronitrile and benzoyl peroxide. In some embodiments of the present disclosure, under the condition that the initiator is a mixture of azobisisobutyronitrile and benzoyl peroxide, the mass ratio of azobisisobutyronitrile and benzoyl peroxide is ranging from 1:1 to 1:3, and more preferably 1:2. In some embodiments of the present disclosure, the initiator is in an amount of 0.1-6% of the total mass of the propylene monomer, the acrylate monomer, and the comonomer, and more preferably 3-5%.

In some embodiments of the present disclosure, the graphene is in an amount of 0.05-1% of the total mass of the propylene monomer, the acrylate monomer, and the comonomer, more preferably 0.1-0.5%. In some embodiments of the present disclosure, the size of the graphene is 1-5 μm. In the present disclosure, under the condition that the amount of graphene (rGO) is too low (<0.05%), the interval between rGO sheets is too large, the arrangement structure that is connected end to end could not be formed, and thus the conductive path could not be established, and the functionality of the modified chemical fiber could not be realized. Under the condition that the amount of rGO is too high (>1%), due to the low bulk density of rGO itself, rGO could not be completely covered by the copolymer molecular chains during the in-situ suspension polymerization, resulting in the formation of aggregates of rGO in the microfibrils and the incomplete one-dimensional alignment, which reduces the mechanical properties of the fiber. Further experiments show that the preferred amount of rGO is in the range of 0.1-0.5%, and the modified chemical fiber obtained exhibits better properties.

In some embodiments of the present disclosure, the mixing is carried out in an ice water bath. In some embodiments, the mixing is carried out under an ultrasonic condition, with a power of 100 W for 2 hours.

After obtaining the mixed solution, according to the present disclosure, the mixed solution was mixed with the aqueous dispersion system, and the resulting mixture is homogenized to obtain a suspension. In some embodiments of the present disclosure, the aqueous phase dispersion system is obtained by blending a dispersant and a salt solution. In some embodiments of the present disclosure, the dispersant includes one or more of magnesium hydroxide, activated calcium phosphate, and polyvinyl alcohol, and more preferably magnesium hydroxide. In some embodiments of the present disclosure, the dispersant is in an amount of 2-11% of the total mass of the propylene monomer, the acrylate monomer, and the comonomer, and more preferably 3.5-6.8%. In some embodiments of the present disclosure, the salt solution is an aqueous solution of sodium nitrite and sodium chloride. In some embodiments of the present disclosure, the mass concentration of the salt solution is in the range of 5-20 wvt %, and more preferably 10 wt %. In some embodiments, the mass ratio of the dispersant to the salt solution is in the range of 0.5-2.75 wt %, and more preferably 0.875-1.7 wt %.

In some embodiments of the present disclosure, the homogenizing is carried out under a high-speed stirring. In some embodiments, the speed of the high-speed stirring is in the range of 10,000-28,000 rpm, and more preferably 10,000-16,000 rpm. In some embodiments, the high-speed stirring is carried out for 5-10 minutes, and more preferably 5-8 minutes. During the homogenizing, the mixed solution composed of monomers and graphene forms an oil-in-water (O/W) system under the action of a dispersant in the aqueous dispersion system, and the dispersant is adsorbed on the monomer/water interface to allow the above monomer to form stable small droplets in the water phase. The subsequent polymerization reaction occurs in these small droplets, and the composite microspheres formed after polymerization could not only achieve the purpose of predispersion of graphene, but also realize the filling modification of different chemical fiber matrices by individually adjusting the properties of the microspheres.

After obtaining the suspension, according to the present disclosure, the suspension is subjected to an in-situ suspension polymerization to obtain a graphene/polymer microsphere. In some embodiments of the present disclosure, the in-situ suspension polymerization reaction is carried out in a protective atmosphere, which could avoid the inhibitory effect of oxygen in the air on the radical polymerization reaction. In some embodiments of the present disclosure, the in-situ suspension polymerization reaction includes a first-stage polymerization reaction and a second-stage polymerization reaction, which are carried out in sequence. In some embodiments, the first-stage polymerization reaction is carried out at a temperature of 50-60° C. for 4-6 hours. In some embodiments, the second-stage polymerization reaction is carried out at a temperature of 70-80° C., for 12-24 hours. The specific reaction that occurs during the first-stage polymerization reaction of the present disclosure is the pre-polymerization reaction of monomers at a lower temperature, to form monomer droplets with higher viscosity. The specific process of the second-stage polymerization reaction is a rapid polymerization of the pre-polymerized monomer droplets at a high temperature, resulting that the droplets are gradually hardened to form graphene/polymer microspheres. In some embodiments of the present disclosure, the temperature is increased from room temperature to the temperature of the first-stage polymerization reaction at a rate of 2° C./min. In some embodiments, the temperature is increased from the temperature of the first-stage polymerization reaction to the temperature of the second stage polymerization reaction at a rate of 5° C./min.

In some embodiments of the present disclosure, the in-situ suspension polymerization reaction is carried out under a stirring condition, and the stirring speed is preferably 200-350 rpm. In the present disclosure, maintaining a stirring state during the in-situ suspension polymerization reaction is to reduce the mutual agglomeration of monomer droplets, especially to avoid the system instability caused by the agglomeration between over-viscous droplets after the viscosity of monomer droplets increases during the second stage.

In some embodiments of the present disclosure, after the in-situ suspension polymerization reaction, the obtained system is washed and dried in sequence to obtain graphene/polymer microspheres. In some embodiments of the present disclosure, the washing includes a hydrochloric acid washing and a water washing, which are carried out in sequence. Hydrochloric acid with a concentration of 1 mol/L is used for the hydrochloric acid washing. In some embodiments of the present disclosure, the drying is a vacuum drying, and the drying is carried out at 60° C. for 48 hours.

In some embodiments of the present disclosure, the graphene/polymer microsphere is a graphene/polyamide microsphere or a graphene/polyacrylate microsphere. In some embodiments, the graphene/polymer microsphere is structured by coating graphene with the polymer microspheres. The graphene/polymer microsphere has an average particle size of 20-200 μm, and more preferably 40-120 μm, and a gel rate of 30-65%, and more preferably 40-55%.

In the present disclosure, under the condition that the average diameter of the graphene/polymer microsphere is less than 20 μm, the rGO sheet could not be completely coated, and part of rGO will be adhered to the surface of the microspheres or free in the water phase, resulting in irregular morphology of the microspheres, instability in the polymerization process and agglomeration of the products. Under the condition that the average diameter of the graphene/polymer microsphere is greater than 200 μm, due to the hydrophobic nature of rGO, the proportion of the blank (without rGO) in the microsphere is increased, which in turn leads to an increase in the unevenness of the cross-linked structure of the microsphere. The above-mentioned problems lead to the aggravation of the rupture of the microspheres in the fiber-forming flow field, a large number of microsphere phases without rGO appear. The dispersion of rGO is reduced, and a one-dimensional alignment structure could not be formed.

Further experiments show that under the condition that the microsphere has an average particle size of 40-120 μm, and the microfibrils has a relatively high (>50) aspect ratio, and the rGO has a better dispersion state and is arranged in a one-dimensional orientation.

After the graphene/polymer microsphere is obtained, according to the present disclosure, the graphene/polymer microsphere and the chemical fiber matrix are mixed in a twin-screw extruder, and subjected to a melt blending, an extrusion, and a drawing, and the modified chemical fiber filled with a multi-oriented graphene/polymer composite is obtained. In some embodiments of the present disclosure, the mass ratio of the graphene/polymer microsphere and the chemical fiber matrix is in the range of 10-50:50-90, and more preferably 20:80. In some embodiments of the present disclosure, the chemical fiber matrix includes nylon (PA), polyester (PET), polyacrylonitrile (PAN), polypropylene (PP), or polymethyl methacrylate (PMMA). In the present disclosure, there is no special requirement on the size of the chemical fiber matrix, and any conventional chemical fiber slice in this field may be used.

In some embodiments of the present disclosure, the melt blending is performed under conditions: a screw speed of 20-40 rpm, and a barrel temperature of 160-280° C.; more preferably a screw speed of 30 rpm, and a barrel temperature of 220-260° C. In specific embodiments of the present disclosure, the barrel temperature is 165° C., 240° C., 245° C., 240° C., or 155° C., 230° C., 235° C., 230° C.

In some embodiments of the present disclosure, the graphene/polymer microsphere and the chemical fiber matrix are pre-mixed before adding them to a twin-screw extruder. In some embodiments of the present disclosure, the specific procedures of the pre-mixing are as follows: mixing the graphene/polymer microsphere and the chemical fiber matrix by oscillating. In some embodiments, the oscillating is performed in a vortex oscillator. In some embodiments, the oscillating is performed for 10 minutes. In some embodiments of the present disclosure, the feed speed added to the twin-screw extruder is 30-80% of the screw rotation speed.

In some embodiments of the present disclosure, the extruded fiber is cooled, and then drawn, to obtain a modified chemical fiber filled with a multi-oriented graphene/polymer composite. In some embodiments of the present disclosure, the drawing is performed under conditions, a drawing speed of 1,000-9,000 m·min⁻¹, and more preferably 2,500-4,500 m·min⁻¹; a thermal drawing ratio of 1-16, and more preferably 6-10.

In the present disclosure, after graphene is coated, the interface interaction between the graphene and the polymer microsphere is strong, and the shear-tensile stress generated by the fiber-forming flow field is effectively transferred to the graphene/polymer microspheres and graphene particles, which induces their continuous deformation and oriented alignment in the fiber forming process. During which, the rearrangement of graphene in the confined space occurs in the polymer microspheres, which improves the control precision of the orientation alignment structure of graphene, effectively improves the filling efficiency of graphene, and reduces the filling amount of graphene. Among them, the fiber-forming flow field includes two parts: a shear flow field and a drawing flow field. The shear flow field mainly exists in the twin-screw extruder. In the process, a shear stress is applied to the molten chemical fiber matrix and polymer microspheres by a counter-rotating screw, to make them mixed to be uniform.

The drawing flow field mainly exists in a drawing process. By drawing the extruded fiber, the chemical fiber matrix and the polymer microspheres in it are deformed and elongated and their diameter decreases under the drawing flow field, and the microspheres are gradually stretched and deformed into microfibrils with high aspect ratio (length/diameter).

According to the present disclosure, graphene is coated through an in-situ suspension polymerization, and is oriented and aligned under the action of the fiber-forming flow field, such that the graphene particles are aligned in a one-dimensional orientation inside the fiber, thereby forming a microfibril structure, and constructing a fiber structure similar to “island”.

The present disclosure also provides a modified chemical fiber filled with a multi-oriented graphene/polymer composite prepared by the method as described in the above technical solutions, wherein an oriented microfibril structure is formed in the fiber by the polymer microsphere, and the graphene is oriented in the microfibril structure. In a specific embodiment of the present disclosure, a microfibril structure with an average diameter of 200 nm and an aspect ratio of more than 50, paralleling to the axial direction of the chemical fiber, is distributed in the chemical fiber.

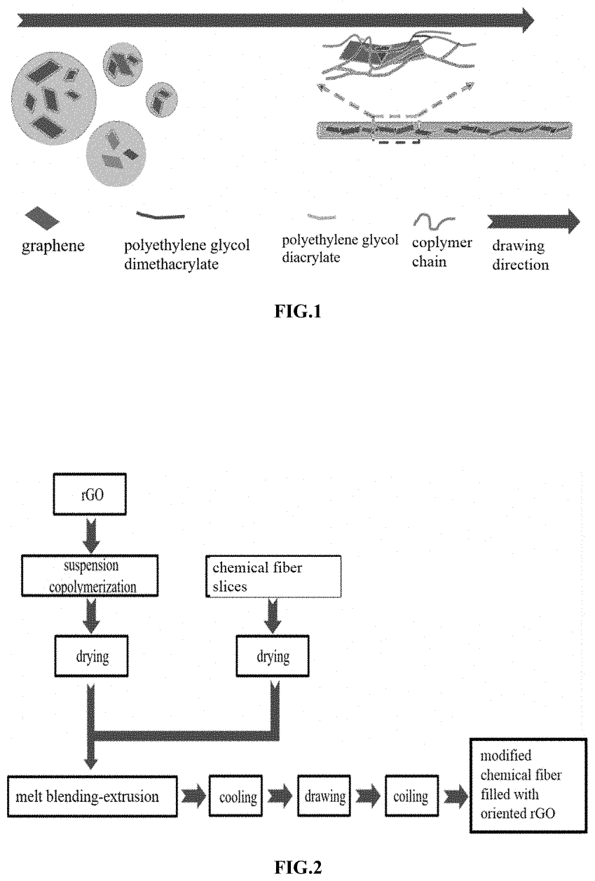

FIG. 1 shows the orientation deformation mechanism of graphene/polymer microspheres in a specific embodiment of the present disclosure. As shown in FIG. 1, the graphene/polymer microspheres are oriented under the drawing flow field, and the copolymer molecular chains adsorbed and entangled on the surface of the graphene are gradually aligned under the action of the drawing flow field. The graphene originally randomly distributed in the microsphere is rearranged under the action of the tensile stress to form an oriented alignment structure along the axial direction of the microfibrils. Therefore, a multi-oriented microfibril structure is formed by graphene and polymer, and it imparts excellent performance to the modified chemical fiber.

The technical solutions of the present disclosure will be described clearly and completely below in conjunction with the embodiments of the present disclosure. Obviously, the described embodiments are only a part of the embodiments of the present disclosure, rather than all the embodiments. On the basis of the embodiments of the present disclosure, all other embodiments obtained by those of ordinary skill in the art without creative work shall fall within the protection scope of the present disclosure.

### Example 1

A modified chemical fiber filled with an oriented graphene/polymer composite was prepared according to the preparation flow chart shown in FIG. 2. 0.1 g of graphene, 10 g of methyl methactylate (MMA), 40 g of butyl acrylate (BA), 50 g of styrene (St), 0.2 g of poly(ethylene glycol) dimethacrylate (PEGDMA-750), 0.2 g of poly(ethylene glycol) diacrylate (PEGDA-200), 2 g of benzoyl peroxide (BPO) and 1 g of azodiisobutyronitrile (AIBN) were mixed and dispersed under an ultrasonic condition (with a power of 100 W) for 2 hours, obtaining a mixed solution. The mixed solution was mixed with an aqueous dispersion system, and they were subjected to a high shear mixing for 5 minutes at a stirring speed of 10,000 rpm, obtaining a suspension, wherein the aqueous dispersion system was prepared according to the following procedures: 6.85 g of magnesium hydroxide, 0.25 g of NaNO₂, and 50 g of NaCl were uniformly dispersed in 500 g of deionized water. The suspension was subjected to a polymerization reaction in high-purity nitrogen according to the following procedures: the suspension was heated to 50° C. at a rate of 2° C./min and maintained at 50° C. for 6 hours: the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours, obtaining a graphene/polyacrylate microsphere (with a particle size of 62 μm).

The graphene/polyacrylate microspheres and PMMA slices were mixed by an oscillating with a blending ratio of 20:80 for 10 minutes, and then added to a twin-screw extruder with a feed speed of 18 rpm. They were subjected to a melt blending, an extrusion, and a drawing to 6 times original length (the rotational speed of the screw during the melt blending was 30 rpm, and the barrel temperature was 165° C., 240° C., 245° C., 240° C., and the drawing speed during the drawing was 3000 m·min⁻¹), obtaining a modified PMMA fiber filled with oriented graphene.

### Example 2

This example was basically the same as Example 1, except that the masses of MMA, BA, and St were 40 g, 20 g, and 40 g, respectively.

### Example 3

This example was basically the same as Example 1, except that the masses of MMA, BA, and St were 50 g, 30 g, and 20 g, respectively.

### Test Example 1

The mechanical properties of the modified PMMA fibers filled with oriented graphene as prepared in Examples 1 to 3 and pure PMMA fiber are shown in Table 1.

TABLE 1
The mechanical properties of the modified PMMA fibers in Examples 1 to
3 and pure PMMA fiber

| | Tensile | Elongation at | Breaking | Young's |
|---|---|---|---|---|
| Sample | strength, MPa | break, % | energy, J/m² | modulus, MPa |
| PMMA | 58.63 | 12.1 | 2507.7 | 3242.1 |
| Example 1 | 64.91 | 19.3 | 2756.0 | 3437.2 |
| Example 2 | 60.97 | 31.03 | 3865.3 | 3401.3 |
| Example 3 | 64.31 | 20 | 2810.7 | 3358.5 |

In the present disclosure, as the amount of MMA and St increases to the appropriate range (too little BA would cause the microspheres to be too rigid to be deformed), the compatibility between the graphene/polyacrylate microspheres (as a dispersed phase) and the PMMA matrix increases, and the interaction between the graphene and PA microspheres is enhanced, and thus the graphene dispersion effect is increased. Therefore, the obtained modified chemical fiber exhibits increased strength and elongation.

### Test Example 2

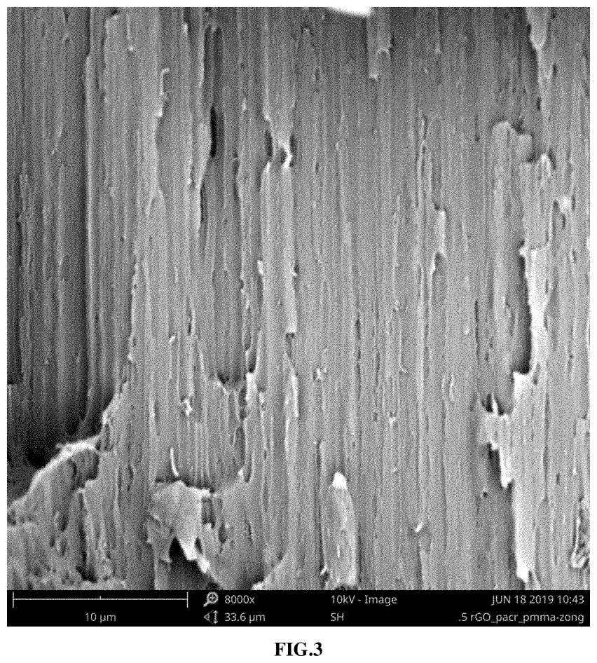

The SEM image of the longitudinal cross-section of the modified PMMA fiber filled with oriented graphene prepared in Example 1 is shown in FIG. 3. As can be seen from FIG. 3, regular and dense microfibrils, paralleling to the axial direction of the fibers, are distributed in PMMA fibers, constructing an “island” structure. This microfibril structure with high aspect ratio improves the toughness of the fibers.

### Example 4

0.1 g of graphene, 40 g of N,N-dimethylacrylamide, 20 g of BA, 40 g of St, 0.2 g of PEGDMA-750, 0.2 g of PEGDA-200, 2 g of BPO and 1 g of AIBN were mixed and dispersed under an ultrasonic condition (with a power of 100 W) for 2 hours, obtaining a mixed solution. The mixed solution was mixed with an aqueous dispersion system, and they were subjected to a high shear stirring for 5 minutes at a stirring speed of 10,000 rpm, obtaining a suspension, wherein the aqueous dispersion system was prepared according to the following procedures: 6.85 g of magnesium hydroxide, 0.25 g of NaNO₂ and 50 g of NaCl were uniformly dispersed in 500 g of deionized water. The suspension was subjected to a polymerization reaction in high-purity nitrogen according to the following procedures: the suspension was heated to 50° C. at a rate of 2° C./min and maintained at 50° C. for 6 hours: the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours obtaining a graphene/polyamide microsphere (with a particle size of 43 μm).

The graphene/polyamide microspheres and PA6 slices were mixed by an oscillating with a blending ratio of 20:80 for 10 minutes, then added to a twin-screw extruder with a feed speed of 18 rpm. They were subjected to a melt blending, an extrusion, and a drawing to 6 times original length (the rotational speed of the screw during the melt blending was 30 rpm, and the barrel temperature was 155° C., 230° C., 235° C., 230, and the drawing speed during the drawing was 4000 m-min-), obtaining a modified PA fiber filled with oriented graphene.

### Test Example 3

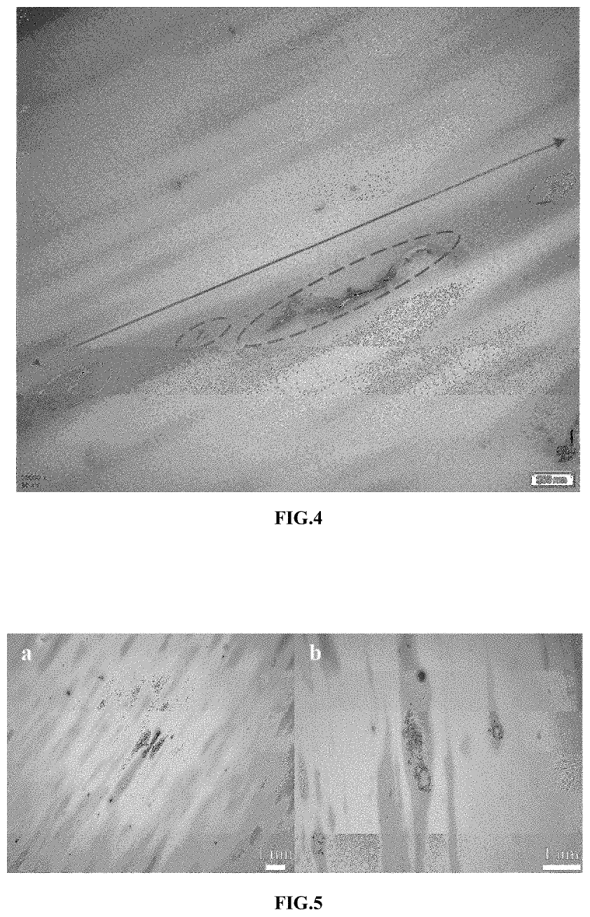

The structure of the modified PA fiber filled with oriented graphene obtained in Example 4 was analyzed, and the longitudinal section of the modified PA fiber filled with oriented graphene was observed by using a transmission electron microscope. The results were shown in FIG. 4. As can be seen from FIG. 4, a microfibril structure (darker area) with a high aspect ratio is formed in the longitudinal section, and the microfibrils are aligned in parallel, and oriented in the direction of the axial direction of the modified PA fiber filled with oriented graphene. Inside the microfibril structure, the graphene sheets aligned along the orientation direction can be observed, and the graphene sheets are in a stretched, oriented state under the action of the drawing flow field, so that the high aspect ratio oriented microfibril structure and the highly-dispersed graphene alignment constructs a multi-oriented structure, which is beneficial to improve the mechanical properties and conductivity of the modified PA fiber.

### Example 5

0.1 g of graphene, 40 g of N,N-dimethylacrylamide. 20 g of BA, 40 g of St, 0.05 g of PEGDMA-750, 0.05 g of PEGDA-200, 2 g of BPO, and 1 g of AIBN were mixed, and dispersed for 2 hours under an ultrasonic condition (with a power of 100 W) to obtain a mixed solution. The mixed solution was mixed with an aqueous dispersion system, and they were subjected to a high shear mixing for 5 minutes at a stirring speed of 10,000 rpm, obtaining a suspension, wherein the aqueous phase dispersion system was prepared according to the following procedures: 6.85 g of magnesium hydroxide, 0.25 g of NaNO?, and 50 g of NaCl were uniformly dispersed in 500 g of deionized water. The suspension was subjected to a polymerization reaction in high-purity nitrogen according to the following procedures: the suspension was heated to 50° C. at a rate of 2° C./min and maintained at 50° C. for 6 hours; the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours, obtaining a graphene/polyamide microsphere (with particle size of 68 μm).

The graphene/polyamide microspheres and PA6 slices were mixed by oscillating for 10 minutes with a blending ratio of 20:80, then added to a twin-screw extruder with a feed speed of 18 rpm. They were subjected to a melt blending, an extrusion, and a drawing to 6 times original length (the rotational speed of the screw during the melt blending was 30 rpm, and the barrel temperature was 155° C., 230° C., 235° C., 230° C.; the drawing speed during the drawing was 4,000 m·min⁻¹), obtaining a modified PA fiber filled with oriented graphene.

### Example 6

0.1 g of graphene. 40 g of N,N-dimethylacrylamide, 20 g of BA, 40 g of St, 0.25 g of PEGDMA-750, 0.25 g of PEGDA-200, 2 g of BPO, and 1 g of AIBN were mixed, and dispersed for 2 hours under an ultrasonic condition (with a power of 100 W) to obtain a mixed solution. The mixed solution was mixed with an aqueous dispersion system, and they were subjected to a high shear mixing for 5 minutes at a stirring speed of 10,000 rpm, obtaining a suspension, wherein the aqueous dispersion system was prepared according to the following procedures: 6.85 g of magnesium hydroxide, 0.25 g of NaNO₂, and 50 g of NaCl were uniformly dispersed in 500 g of deionized water. The suspension was subjected to a polymerization reaction in high-purity nitrogen according to the following procedures: the suspension was heated to 50° C. at rate of 2° C./min and maintained at 50° C. for 6 hours: the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours, obtaining a graphene/polyamide microsphere (with a particle size of 54 μm);

The graphene/polyamide microspheres and PA6 slices were mixed by oscillating with a blending ratio of 20:80 for 10 minutes, and then added to a twin-screw extruder with a feed speed of 18 rpm. They were subjected to a melt blending, an extrusion, and a drawing to 6 times original length (the rotational speed of the screw during the melt blending was 30 rpm, and the barrel temperature was 155° C., 230° C. 235° C., 230° C. and the drawing speed during the drawing was 4000 m·min⁻¹), obtaining a modified PA fiber filled with oriented graphene.

### Test Example 4

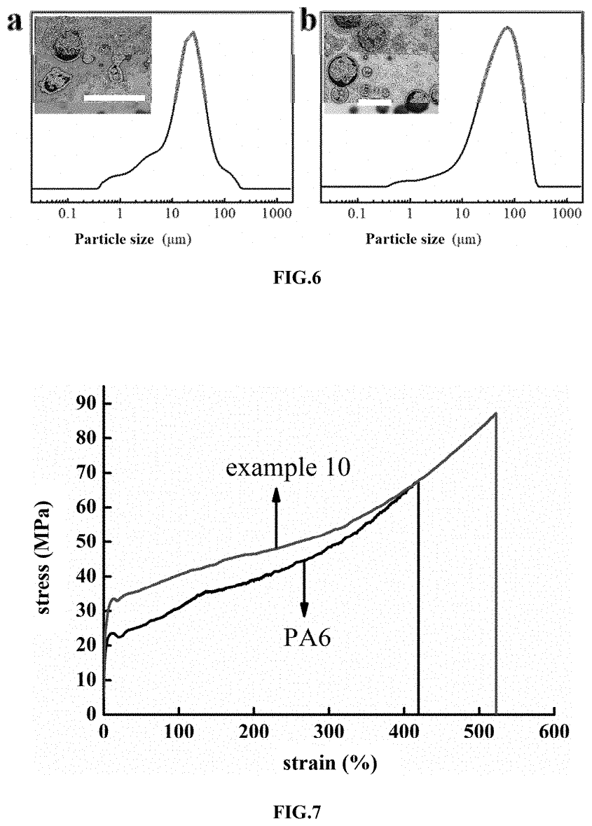

The TEM images of the longitudinal section of the modified PA fibers filled with oriented graphene prepared in Examples 5 to 6 are shown in FIG. 5, in which a in FIG. 5 represents the modified PA fiber of Example 5, and b in FIG. 5 represents the modified PA fiber of Example 6. As can be seen from FIG. 5, when the amount of crosslinking agent is small, the resulting cross-linked microspheres are dissociated under the action of the shear flow field in the extruder, forming smaller fragments, and thus the microfibrils formed from which have a relatively lower aspect ratio. When the amount of crosslinking agent is large, the gel rate of the microsphere is large, and thus microspheres are oriented and deformed to a low extent in the fiber-forming flow field, forming microfibrils with a larger diameter.

The mechanical properties of modified PA fibers filled with oriented graphene prepared in Examples 5 to 6 and pure PA6 fibers are shown in Table 2.

TABLE 2
The mechanical properties of modified PA fibers of Examples 5 to 6 and
pure PA6 fibers

| | Tensile strength, | Elongation at | Breaking | Young's |
|---|---|---|---|---|
| Sample | MPa | break, % | energy, J/m² | modulus, MPa |
| PA6 | 55.6 | 389 | 75318 | 14.6 |
| Example 5 | 57.2 | 423 | 78308 | 16.5 |
| Example 6 | 57.9 | 412 | 85451 | 17.2 |

### Example 7

0.05 g of graphene, 40 g of N,N-dimethylacrylamide, 20 g of BA, 40 g of St, 0.2 g of PEGDMA-750, 0.2 g of PEGDA-200, 2 g of BPO, and 1 g of AIBN were mixed, and dispersed under an ultrasonic condition (with a power of 100 W) for 2 hours, obtaining a mixed solution. The mixed solution was mixed with an aqueous dispersion system, and they were subjected to a high shear mixing for 5 minutes at a stirring speed of 10,000 rpm, obtaining a suspension, wherein the aqueous phase dispersion system was prepared according to the following procedure: 10.3 g of magnesium hydroxide. 0.25 g of NaNO₂ and 50 g of NaCl were uniformly dispersed in 500 g of deionized water. The suspension was subjected to a polymerization reaction in high-purity nitrogen according to the following procedures: the suspension was heated to 50° C. at a rate of 2° C./min and maintained at 50° C. for 6 hours: the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours, obtaining a graphene/polyamide microsphere (with a particle size of 21 μm).

The graphene/polyamide microspheres and PA6 slices were mixed by oscillating with a blending ratio of 20:80 for 10 minutes, and then added to a twin-screw extruder with a feed speed of 18 rpm. They were subjected to a melt blending, an extrusion, and a drawing to 6 times original length (the rotational speed of the screw during the melt blending was 30 rpm, and the barrel temperature was 155° C., 230° C., 235° C. 230° C., and the drawing speed during the drawing was 4,000 m·min⁻¹), obtaining a modified PA fiber filled with oriented graphene.

### Example 8

0.5 g of graphene, 40 g of N,N-dimethylacrylamide, 20 g of BA, 40 g of St. 0.2 g of PEGDMA-750, 0.2 g of PEGDA-200, 2 g of BPO, and 1 g of AIBN were mixed, and dispersed for 2 hours under an ultrasonic condition (with a power of 100 W), obtaining a mixed solution. The mixed solution was mixed with an aqueous dispersion system, and they were subjected to a high shear mixing for 5 minutes at a stirring speed of 10,000 rpm, obtaining a suspension, wherein the aqueous dispersion system was prepared according to the following procedures: 3.5 g of magnesium hydroxide, 0.25 g of NaNO₂, and 50 g of NaCl were uniformly dispersed in 500 g of deionized water. The suspension was subjected to a polymerization reaction in high-purity nitrogen according to the following procedures: the suspension was heated to 50° C. at a rate of 2° C./min and maintained at 50° C. for 6 hours: the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours, obtaining a graphene/polyamide microsphere (with a particle size of 107 μm).

The graphene/polyamide microspheres and PA6 slices were mixed by oscillating with a blending ratio of 20:80 for 10 minutes, and then added to a twin-screw extruder with a feed speed of 18 rpm. They were subjected to a melt blending, an extrusion, and a drawing to 6 times original length (the rotational speed of the screw during the melt blending was 30 rpm, and the barrel temperature was 155° C., 230° C., 235° C. 230° C. and the drawing speed during the drawing was 4,000 m·min⁻¹), obtaining a modified PA fiber filled with oriented graphene.

### Test Example 5

The optical pictures and particle size distribution of the graphene/polyamide microspheres prepared in Examples 7 to 8 are shown in FIG. 6, in which a in FIG. 6 represents a graphene/polyamide microsphere of Example 7, b in FIG. 6 represents a graphene/polyamide microsphere of Example 8. As can be seen from FIG. 6, graphene is coated inside the PA microspheres, and the particle size of the microsphere is smaller when the amount of dispersant is larger, which would be beneficial to the orientation of microspheres in the fiber forming flow field and the improvement of the mechanical properties of the modified PA6 fibers.

### Example 9

0.1 g of graphene, 40 g of N,N-dimethylacrylamide, 20 g of BA, 40 g of St, 0.2 g of PEGDMA-750, 0.2 g of PEGDA-200, 2 g of BPO, and Ig of AIBN were mixed, and dispersed under an ultrasonic condition (with a power of 100 W) for 2 hours, obtaining a mixed solution. The mixed solution was mixed with an aqueous dispersion system, and they were subjected to a high shear mixing for 5 minutes at a stirring speed of 10,000 rpm, obtaining a suspension, wherein the aqueous phase dispersion system was prepared according to the following procedure: 6.85 g of magnesium hydroxide, 0.25 g of NaNO₂, and 50 g of NaCl were uniformly dispersed in 500 g of deionized water. The suspension was subjected to a polymerization reaction in high-purity nitrogen according to the following procedures: the suspension was heated to 50° C. at a rate of 2° C./min and maintained at 50° C. for 6 hours; the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours, obtaining a graphene/polyamide microsphere (with a particle size of 61 μm).

The graphene/polyamide microspheres and PA6 were mixed by oscillating with a blending ratio of 10:90 for 10 minutes, and then added to a twin-screw extruder with a feed speed of 18 rpm. They were subjected to a melt blending, an extrusion, and a drawing to 1 time original length (the rotational speed of the screw during the melt blending was 30 rpm, and the barrel temperature as 155° C., 230° C., 235° C., 230° C.; and the drawing speed during the drawing was 4,000 m·min⁻¹), obtaining a modified PA fiber filled with oriented graphene.

### Example 10

This example was basically the same as Example 9, except that the mass ratio of graphene/polyamide microspheres to PA6 slices was “35: 65” rather than “10: 90”, and the drawing ratio was “9 times” rather than “1 time”.

### Example 11

This example was basically the same as Example 9, except that the mass ratio of graphene/polyamide microspheres to PA6 slices was “50: 50” rather than “10: 90”, and the drawing ratio was “16 times” rather than “1 time”.

### Test Example 6

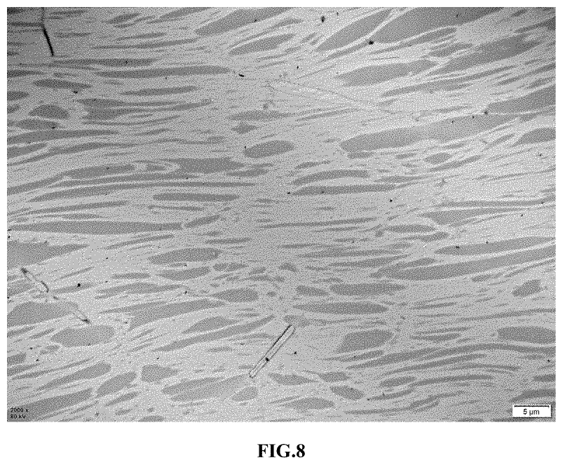

The mechanical properties of the modified PA fibers filled with oriented graphene prepared in Examples 9 to 11 are shown in Table 3, and the stress-strain curves of the modified PA fibers filled with oriented graphene obtained in Example 10 and pure PA fibers are shown in FIG. 7.

TABLE 3
Mechanical properties of modified PA fibers in Examples 9 to 11

| | Tensile strength, | Elongation at | Breaking | Young's |
|---|---|---|---|---|
| Example | MPa | break, % | energy, J/m² | Modulus, MPa |
| Example 9 | 59.2 | 398 | 108297 | 19.0 |
| Example 10 | 86.9 | 521 | 140294 | 23.5 |
| Example 11 | 78.2 | 467 | 128449 | 21.2 |

From Table 3 and FIG. 7, it can be seen that after a proper drawing, the strength and toughness of modified PA fiber are significantly improved compared with PA6 fiber.

### Comparative Example 1

40 g of N-methacrylamide, 20 g of BA, 40 g of St, 0.2 g of PEGDMA-550, 0.2 g of PEGDA-1000, 2 g of BPO, and 1 g of AIBN were mixed, and dispersed for 2 hours under an ultrasonic condition (with a power of 100 W), obtaining a mixed solution. The mixed solution was mixed with an aqueous dispersion system and they were subjected to a high shear mixing for 5 min at a stirring speed of 10,000 rpm, obtaining a suspension, wherein the aqueous dispersion system was prepared according to the following procedure: 6.85 g of magnesium hydroxide, 0.25 g of NaNO₂, and 50 g of NaCl were uniformly dispersed in 500 g of deionized water. The suspension was subjected to a polymerization reaction in high-purity nitrogen according to the following procedures, the suspension was heated to 50° C. at a rate of 2° C./min and maintained at 50° C. for 6 hours: the resulting mixture was heated to 70° C. at a rate of 5° C./min, and maintained at 70° C. for 18 hours. The resulting system was washed with 1 mol/L HCl and fully washed with water, and then vacuum dried at 60° C. for 48 hours, obtaining a PA microsphere (with a particle size of 43 μm).

The polyamide microspheres and PA6 slices were mixed by oscillating with a blending ratio of 20:80 for 10 minutes, and then added to a twin-screw extruder with a feed speed of 18 rpm They were subjected to a melt blending, an extrusion, and a drawing to 6 times original length (the rotational speed of the screw during the melt blending was 30 rpm, and the barrel temperature was 155° C., 230° C., 235° C. 230° C., and the drawing speed during the drawing was 4000 m·min⁻¹), obtaining a modified PA fiber filled with oriented graphene.

The axial TEM image of the modified PA fiber obtained in Comparative Example 1 is shown in FIG. 8. As can be seen from FIG. 8, due to the lack of the promotion of graphene, the degree of deformation of the microspheres is lower, and microfibrils with high aspect ratio, which have toughening effect, could not be formed. Therefore, the fibers obtained in this way exhibit poor mechanical properties.

The description of the above embodiments is only used to help understand the method and the core idea of the present disclosure. It should be pointed out that for those of ordinary skill in the art, without departing from the principle of the present disclosure, several improvements and modifications could be made to the present disclosure, and these improvements and modifications also fall within the protection scope of the claims of the present disclosure. Various modifications to these embodiments are obvious to those skilled in the art, and the general principles defined herein could be implemented in other embodiments without departing from the spirit or scope of the present disclosure. Therefore, the present disclosure will not be limited to the embodiments described in this article, but should conform to the widest scope consistent with the principles and novel features disclosed in this article.

1. A method for preparing a graphene/polymer microsphere, comprising:
mixing graphene, a propylene monomer, an acrylate monomer, a comonomer, a macromolecular crosslinking agent, and an initiator, to obtain a mixed solution;
mixing the mixed solution with an aqueous dispersion system and homogenizing, to obtain a suspension; and
subjecting the suspension to an in-situ suspension polymerization reaction to obtain the graphene/polymer microsphere.

2. A method for preparing a modified chemical fiber filled with a multi-oriented graphene/polymer composite, comprising
mixing graphene, a propylene monomer, an acrylate monomer, a comonomer, a macromolecular crosslinking agent, and an initiator, to obtain a mixed solution;
mixing the mixed solution with an aqueous dispersion system and homogenizing, to obtain a suspension;
subjecting the suspension to an in-situ suspension polymerization reaction to obtain a graphene/polymer microsphere; and
mixing the graphene/polymer microsphere and a chemical fiber matrix in a twin-screw extruder, and subjecting the resulting mixture to a melt blending, an extrusion, and a drawing to obtain the modified chemical fiber filled with a multi-oriented graphene/polymer composite.

3. The method as claimed in claim 2, wherein a mass ratio of the propylene monomer, the acrylate monomer, and the comonomer is in the range of 15-50: 10-40: 10-45.

4. The method as claimed in claim 2, wherein the propylene monomer is one or more selected from the group consisting of acrylamide, methacrylamide, ethacrylamide, N-(3-dimethylaminopropyl)-methacrylamide, N,N-dimethylacrylamide, N, N-diethylacrylamide, acrylonitrile, and methyl methacrylate.

5. The method as claimed in claim 2, wherein the acrylate monomer is butyl acrylate or butyl methacrylate.

6. The method as claimed in claim 2, wherein the comonomer is styrene.

7. The method as claimed in claim 2, wherein the macromolecular crosslinking agent is poly(ethylene glycol) dimethacrylate, poly(ethylene glycol) diacrylate, or a mixture thereof; the macromolecule crosslinking agent is in an amount of 0.1-0.5% of the total mass of the propylene monomer, the acrylate monomer, and the comonomer.

8. The method as claimed in claim 7, wherein under the condition that the macromolecular crosslinking agent is a mixture of poly(ethylene glycol) dimethacrylate and poly(ethylene glycol) diacrylate, a mass ratio of poly(ethylene glycol) dimethacrylate to poly(ethylene glycol) diacrylate is ranging from 9: 1 to 1: 9.

9. The method as claimed in claim 2, wherein the initiator is azobisisobutyronitrile, benzoyl peroxide, or a mixture thereof; the initiator is in an amount of 0.1-6% of the total mass of the propylene monomer, the acrylate monomer, and the comonomer.

10. The method as claimed in claim 2, wherein the graphene is in an amount of 0.05-1% of the total mass of the propylene monomer, the acrylate monomer, and the comonomer.

11. The method as claimed in claim 2, wherein the aqueous dispersion system is obtained by mixing a dispersant and a salt solution; the dispersant is one or more selected from the group consisting of magnesium hydroxide, activated calcium phosphate, and polyvinyl alcohol; the salt solution is an aqueous solution of sodium nitrite and sodium chloride.

12. The method as claimed in claim 2, wherein the homogenizing is carried out under a condition of a high-speed stirring, with a stirring speed of 10,000-28,000 rpm.

13. The method as claimed in claim 2, wherein the in-situ suspension polymerization reaction is carried out in a protective atmosphere; the in-situ suspension polymerization reaction is carried out at a temperature of 50-80° C. for 8-24 hours.

14. The method as claimed in claim 2, wherein the graphene/polymer microsphere is structured by coating graphene with polymer, and has an average particle size of 20-200 μm, and a gel rate of 30-65%.

15. The method as claimed in claim 2, wherein a mass ratio of the graphene/polymer microsphere to the chemical fiber matrix is in the range of 10-50: 50-90.

16. The method as claimed in claim 2, wherein the chemical fiber matrix is one selected from the group consisting of nylon, polyester, polyacrylonitrile, polypropylene, and polymethyl methacrylate.

17. A modified chemical fiber filled with a multi-oriented graphene/polymer composite prepared by the method of claim 2, wherein an oriented microfibril structure is formed in the chemical fiber matrix from the graphene/polymer microsphere, in which graphene is oriented.

18. The method as claimed in claim 15, wherein the chemical fiber matrix is one selected from the group consisting of nylon, polyester, polyacrylonitrile, polypropylene, and polymethyl methacrylate.

19. The method as claimed in claim 1, wherein a mass ratio of the propylene monomer, the acrylate monomer, and the comonomer is in the range of 15-50: 10-40: 10-45.

20. The method as claimed in claim 1, wherein the graphene is in an amount of 0.05-1% of the total mass of the propylene monomer, the acrylate monomer, and the comonomer.
